(19) United States
(12) Patent Application Publication
(10) Pub. No.: US 2025/0223460 A1
(43) Pub. Date: Jul. 10, 2025

(54) PHOTOCURABLE COMPOSITIONS FOR ADDITIVE MANUFACTURING AND USE THEREOF

(71) Applicant: Henkel AG & Co., KGaA, Duesseldorf (DE)

(72) Inventors: STEFAN SALDIVAR HINOTE, CONCORD, CA (US); AUSTIN LEVY, CONCORD, CA (US); AVIA BAR, CONCORD, CA (US); DALE BABCOCK, CONCORD, CA (US)

(21) Appl. No.: 19/091,994

(22) Filed: Mar. 27, 2025

Related U.S. Application Data
(63) Continuation of application No. PCT/US2023/076069, filed on Oct. 5, 2023.
(60) Provisional application No. 63/379,052, filed on Oct. 11, 2022.

(51) Int. Cl. C09D 133/14; B29C 64/124; B29C 64/30; B29K 33/00; B29K 105/00; B33Y 40/20; B33Y 70/00; C08F 220/28; C08F 220/36; C09D 4/00

(52) U.S. Cl. CPC C09D 133/14; B33Y 40/20; B33Y 70/00; C08F 220/281; C08F 220/365; C09D 4/00; B29C 64/124; B29C 64/30; B29K 2033/08; B29K 2105/0002; B29K 2105/0085; C08F 2810/20

(57) ABSTRACT

Thermally reversible, photocurable compositions is disclosed. The photocurable composition has high strength at low temperatures but also melts at elevated temperatures and is well suited as additive manufacturing composition.

### FIELD OF THE INVENTION

The present invention relates to photocurable, three-dimensional, printable compositions that polymerize to a solid when exposed to UV light and then softens and melts upon heating. The photocurable compositions are useful in additive manufacturing, particularly for making three-dimensional objects that require removability.

### BACKGROUND OF THE INVENTION

Additive manufacturing, also known as 3D printing, has gained greater prominence in the last decade. Production by layer techniques, linking together to form a simple 3D model or with the 3D scanner can form highly accurate, on-demand production in small or large scale. Additive manufacturing is employed in the production of medical devices, automotive components, aerospace equipment and parts, electronic components, jewelry, fashion, and the like.

The materials for additive manufacturing can be liquid-based, solid-based, or power-based to build a self-supporting structure. Based on the starting material, the additive manufacturing process can be conducted with digital light processing, stereolithography, slot die coating, spray coating, wet-coating, screen-printing UV-nano-imprint lithography or photo-nano imprint lithography, step and flash imprint lithography, selective laser sintering, fused deposition modeling, fused filament fabrication, polyjet, or inkjet printing. Reworkability is important for removability or recycling certain parts for cost or for efficiency.

Fused deposition modeling (FDM) is one of the most common methods of additive manufacturing which extrudes melted thermoplastic materials through a nozzle to form object. The accuracy of the formed object is limited by the nozzle diameter usually ranging from 0.2 to 1 mm. Additive manufacturing via digital light processing (DLP) and stereolithography yield higher accuracy and resolution relative to FDM with comparable strength, however the formed objects do not melt under heating.

There is a need in the art for a highly accurate, high strength, and easily removable materials for three-dimensional printing process. The current invention fulfills this need.

### BRIEF SUMMARY OF THE INVENTION

The invention provides thermally reversible, photocurable compositions for printing three-dimensional or additive manufacturing objects. These three-dimensional objects require strong mechanical strength upon formation but softens and melts upon heating. The softening and melting are useful for reworking or removing parts or the entire object.

In one embodiment, a reworkable, three-dimensional composition comprises:

A) a monomer A with at least one functionality having a glass transition temperature value less than about 25° C.;

B) a monomer B with at least one functionality having a glass transition temperature value greater than about 25° C.;

C) a thermally reversible crosslinker having a UV curable functionality and a thermally reversible covalent bond;

D) a photoinitiator; and

E) an additive selected from the group consisting of a chain transfer agent, irreversible chain transfer agent, antioxidant, hindered amine light stabilizer, amine synergist, optical brighteners, UV blockers, fillers, dyes, waxes, plasticizers or mixtures thereof.

The reworkable, three-dimensional composition may be the basis for forming objects. The photocurable composition can maintain high mechanical strength at temperatures below about 130° C., and softens and melts at temperatures above about 130° C. due to its thermally reversible bonds in the composition.

Another embodiment is directed to forming a reworkable, three-dimensional composition object comprising
1) preparing a reworkable, three-dimensional composition comprising:
   A) a monomer A with at least one functionality having a glass transition temperature value less than about 25° C.;
   B) a monomer B with at least one functionality having a glass transition temperature value greater than about 25° C.;
   C) a thermally reversible crosslinker having a UV curable functionality and a thermally reversible covalent bond;
   D) a photoinitiator; and
   E) an additive selected from the group consisting of a chain transfer agent, irreversible chain transfer agent, antioxidant, hindered amine light stabilizer, amine synergist, optical brighteners, UV blockers, fillers, dyes, waxes, plasticizers or mixtures thereof; and
2) applying the reworkable, three-dimensional composition onto a substrate or depositing the mixture as a self-supporting 3D structure, whereby forming the reworkable, three-dimensional composition object.

Another embodiment is directed to a method of making a reworkable, three-dimensional object comprising the steps of:
1) preparing a reworkable, three-dimensional composition comprising:
   A) a monomer A with at least one functionality having a glass transition temperature value less than about 25° C.;
   B) a monomer B with at least one functionality having a glass transition temperature value greater than about 25° C.;
   C) a thermally reversible crosslinker having a UV curable functionality and a thermally reversible covalent bond;
   D) a photoinitiator; and
   E) an additive selected from the group consisting of a chain transfer agent, irreversible chain transfer agent, antioxidant, hindered amine light stabilizer, amine synergist, optical brighteners, UV blockers, fillers, dyes, waxes, plasticizers or mixtures thereof; and
2) applying the reworkable, three-dimensional composition onto a substrate or depositing the mixture as a self-supporting 3D structure; and
3) drying, curing or hardening the reworkable, three-dimensional composition whereby forming the reworkable, three-dimensional object
4) optionally, heating a portion of the entirety of the reworkable, three-dimensional object at a temperature at or greater than 130° C. to soften the reworkable, three-dimensional object and
5) optionally, removing the reworkable, three-dimensional object.

### BRIEF SUMMARY OF THE DRAWINGS

FIG. 1 is a schematic drawing of the cured reworkable, three-dimensional composition.

FIGS. 2A-D are Differential Scanning calorimetry (DSC) curves of various compositions.

FIG. 3 is a photograph of Sample 1 tensile specimen, printed vertically having a height of 63 mm.

### DETAILED DESCRIPTION OF THE INVENTION

Three-dimensional objects or additive manufacturing is printing a three-dimensional object from a digital design in a successive layer to create a physical object. Various methods including FDM (fused deposition modeling), SLA (stereolithography), SLS (selective laser sintering) or LCD (liquid crystal display) are often used to print the object. Depending on the desired object's physical properties and the printer, appropriate additive manufacturing composition is selected. This composition may be powder (thermoplastic, wax, ceramic, metal) and utilizes light or heat source to sinter/melt/fuse layers of the powder together. Jetting fine droplets is another additive manufacturing technique. Extrusion of PLA or ABS in filament form can also build layers and create predetermined shapes. Since objects can be printed and directed with the printer, very detailed and intricate objects, even with functionality built in and negating the need of assembly can be tailored with additive manufacturing.

The three-dimensional objects are photocurable with actinic radiation, which are electromagnetic radiation that can produce photochemical reactions.

The term melting point of a substance herein refers to the temperature at which it changes state from solid to liquid. At the melting point the solid and liquid phase exist in equilibrium. The term softening point herein refers to the temperature at which a substance softens, particularly the temperature at which an amorphous material starts to soften.

A monomer herein is defined as molecule that can be polymerizable into an oligomer or a polymer. The monomer may be monofunctional having a single functional polymerizable group or a multifunctional monomer which has more than one functional polymerizable group. The molecular weight of the monomer can be low molecular weight (e.g., about 100 to about 1,000 Daltons), medium molecular weight (e.g., about 1000 to about 5,000 Daltons) or high molecular weight (about 5,000 to about 20,000 Daltons). “Oligomer” refers to a defined, small number of repeating monomer units such as 10-5,000 units, and advantageously 10-1,000 units which have been polymerized to form a molecule. Oligomers are a subset of the term polymer. “Polymer” refers to any polymerized product greater in chain length and molecular weight than the oligomer. Polymers can have a degree of polymerization of about 50 to about 25000.

The invention provides thermally reversible, photocurable compositions for additive manufacturing. The composition maintains high mechanical properties until it is triggered to soften and to be removed. In one embodiment, the photocurable composition comprises:
A) a monomer A with at least one functionality having a glass transition temperature value less than about 25° C.;
B) a monomer B with at least one functionality having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, reversible chain transfer agent (RAFT), antioxidant, hindered amine light stabilizer, amine synergist, optical brighteners, UV blockers, fillers, dyes, waxes, plasticizers or mixtures thereof.

The photocurable composition requires a combination of cationically curable or radically curable monomers to form a polymeric backbone. A combination of a monomer A having a glass transition temperature value less than about 25° C. and a monomer B having a glass transition temperature value greater than about 25° C. provides a polymeric network suitable for additive manufacturing e.g., 3D printing.

The backbone is formed with at least two monomers, each monomer independently having at least one functional group selected from (meth)acrylates, acrylates, vinyl esters, vinyl, ethers, allyl, N-vinyls, vinylamides, thiols, (meth)acrylamides, vinyl carbonates, acryloyls, vinyl carbamates, maleimides, cyanoacrylates, thiols and epoxides, styrenics, vinyl halides, acrylonitriles, nadimides, itaconimides, and vinyl ether. The term “backbone” is intended to refer to a chemical moiety to which or between which the functional group(s) are attached. In another embodiment, the backbone is formed with a single monomer.

The monomer A has a glass transition (Tg) temperature value less than about 25° C., preferably less than about 0° C., and most preferably less than about −15° C., and contains at least one reactive group listed above. The functional group of monomer A is particularly preferred to be a methacrylate or acrylate. Particularly preferred examples of monomer A includes lauryl acrylate (Tg=15° C.), lauryl methacrylate (Tg=−65° C.), isodecyl acrylate (Tg=−58° C.), isodecyl methacrylate (Tg=—70° C.), 2-propylheptyl acrylate (Tg=−68° C.), isobutyl acrylate (Tg=—24° C.), ethyldiglycol acrylate (Tg=−53° C.), heptadecyl acrylate (Tg=−64° C.), and 4-hydroxybutyl acrylate (Tg=−65° C.).

Monomer A is present in ranges from about 1 to about 30 wt %, preferably about 3 to about 15 wt %, of the total photocurable composition.

The monomer B has a glass transition temperature value greater than about 25° C., preferably greater than 50° C., more preferably greater than 75° C. The monomer B is particularly preferred to contain methacrylate, acrylate, vinyl ester, vinyl, ether, allyl, N-vinyl, vinylamide, acrylamide, vinyl carbonate, acryloyl, vinyl carbamate, maleimide, cyanoacrylate, thiol or epoxide functional group.

Examples of the reactive group in monomer B group include isobornyl acrylate (Tg=95° C.), isobornyl methacrylate (Tg=110° C.), n-vinyl caprolactam (Tg=125° C.), cyclohexyl methacrylate (Tg=92° C.), hydroxyethyl methacrylate (Tg=55° C.), hydroxypropyl methacrylate (Th=76° C.), phenyl methacrylate (Tg=110° C.), methacrylic acid (Tg=228° C.), acrylamide (Tg=165° C.), n-vinyl pyrrolidone (Tg=150° C.), acryloyl morpholine (Tg=145° C.), and n,n-dimethyl acrylamide (Tg=119° C.).

Monomer B is present in ranges from about 10 to about 75 wt %, preferably about 20 to about 60 wt %, more preferably about 25 to about 55 wt % of the total photocurable composition.

The combination of the two monomers having varied Tg allows for a balanced property of high strength and ductility and modulus. If the monomer combination in the photocurable composition exhibited too high Tg, e.g., greater than 100° C., then the resultant polymers will exhibit high viscosity when heated, which will have difficulty with softening. In contrast, if the monofunctional monomer used have too low of Tg, e.g., below 20 C then the resultant polymer will exhibit poor mechanical properties and the photocurable composition will deform under any applied stress.

The combined monomers, in the above ranges, with thermally reversible crosslinker provides sufficient mechanical and physical properties in softness and tensile strength and formability while retaining the capability to melt.

Modulus of the backbone, monomer A and monomer B, with the thermally reversible crosslinker should be greater than about 10 MPa of Young's modulus, in accordance with ASTM D638.

The photocurable composition further comprises a thermally reversible crosslinker. The thermally reversible crosslinkers have a UV curable functionality and a thermally reversible covalent bond. The thermally reversible crosslinker is prepared by reacting:
a) bismaleimide or a compound having to two or more maleimide group with
b) furfuryl methacrylate or furfuryl acrylate
   Where the molar ratio of a to b is 1:0.5 to 1:2.

In one embodiment, the thermally reversible crosslinker is prepared by reacting a bismaleimide with two molar equivalents of furfuryl methacrylate. In another, the thermally reversible crosslinker is prepared by reacting a bismaleimide with two molar equivalents of furfuryl acrylate. In yet another embodiment, the thermally reversible crosslinker is prepared by reacting a starting material containing two or more maleimide groups with half molar to one molar equivalent of furfuryl methacrylate per maleimide. In another embodiment, the thermally reversible crosslinker is prepared by reacting a starting material containing two or more maleimide groups with half molar to one molar equivalent of furfuryl acrylate per maleimide. In another embodiment, the thermally reversible crosslinker is prepared by reacting a bismaleimide with two molar equivalents of reactant containing one furfuryl and one methacrylate group. In yet another embodiment, the thermally reversible crosslinker is prepared by reacting a bismaleimide with two molar equivalents of reactant containing one furfuryl and one acrylate group.

The Diels-Alder reaction forms an adduct of bismaleimide and furfuryl acrylate at temperature up to about 80° C.; and the adduct is thermally reversible through retro Diels-Alder reaction, at about 80 to about 180° C. The adduct can be formed as the temperature is ramped up to about 80° C., and once the adduct reaches the reversal temperature from about 80 to 180° C., the bond dissociates. For best way to dissociate the adduct, the adduct is held at above the reversal temperature for a minimum time. The temperature and time can be determined by with experimentation by those skilled in the art, e.g., higher temperature for shorter length time or lower temperature for longer length of time.

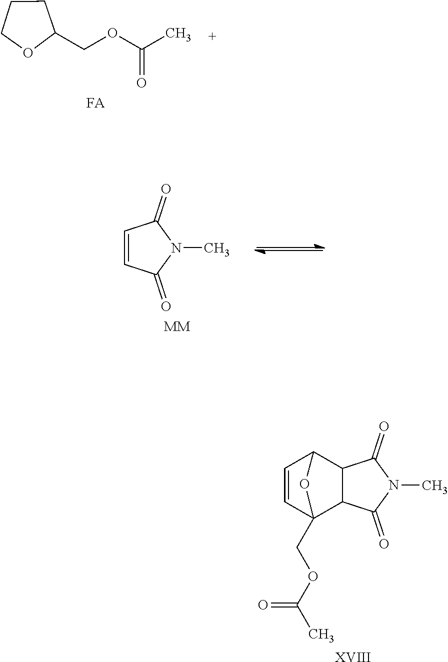

The thermally reversible crosslinker forms a network reaction of polymers with pendant furan and/or maleimide heterocycles.

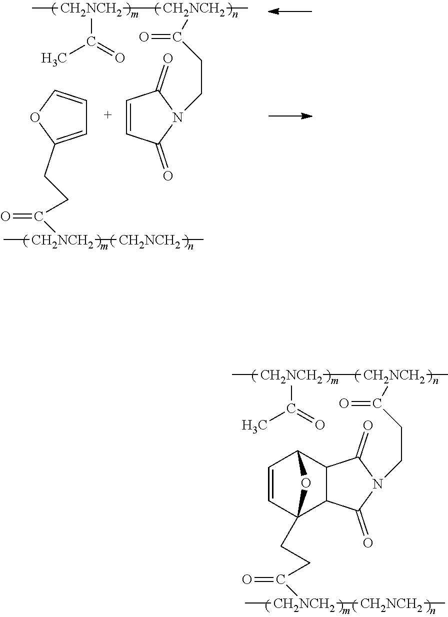

The stereochemistry and actual position of the furan or bismaleimide within the polymer chain determines its reactivity.

In one example, the thermally reversible crosslinker is furan-maleimide Diels-Alder adduct of bismaleimide (1,1′-(Methylenedi-4,1-phenylene)bismaleimide, reacted with two molar equivalents of furfuryl methacrylate to form (methylenebis(4,1-phenylene))bis(1,3-dioxo-2,3,3a,4, 7, 7a-hexahydro-1H-4, 7-epoxyisoindole-2,5-diyl) bis(2-methylacrylate).

In yet another embodiment, the thermally reversible crosslinker is prepared by reacting a polyimide bearing pendant maleimide functions and a trifuran derivative.

In one embodiment, the thermally reversible crosslinker is prepared by reacting a bismaleimide with two molar equivalents of furfuryl glycidyl ether. In another embodiment, the thermally reversible crosslinker is prepared by reacting a starting material containing two or more maleimide groups with half molar to one molar equivalent of furfuryl glycidyl ether per maleimide.

In another embodiment, the thermally reversible crosslinker is prepared by reacting a bismaleimide with two molar equivalents of reactant containing one furfuryl and one epoxy group.

In another embodiment, the thermally reversible crosslinker is prepared by reacting a bismaleimide with two molar equivalents of reactant containing one furfuryl and one acrylamide group.

In another embodiment, the thermally reversible crosslinker is prepared by reacting a bismaleimide with two molar equivalents of reactant containing one furfuryl and one methacrylamide group.

In another embodiment, the thermally reversible crosslinker is prepared by reacting a bismaleimide with two molar equivalents of reactant containing one furfuryl and one vinyl group.

In another embodiment, the thermally reversible crosslinker is prepared by reacting a bismaleimide with two molar equivalents of reactant containing one furfuryl and one vinyl ester group.

In another embodiment, the thermally reversible crosslinker is prepared by reacting a bismaleimide with two molar equivalents of reactant containing one furfuryl and one vinyl ether group.

In another embodiment, the thermally reversible crosslinker is prepared by reacting a bismaleimide with two molar equivalents of reactant containing one furfuryl and one cyanoacrylate group.

The thermally reversible crosslinker can have varied molecular ranges from low (about 500 to about 1,000 Daltons), medium (about 1,000 to about 5,000) and high (5,000 to about 10,000 Daltons). Depending on factors such as the viscosity, kinetics, miscibility, and the like, a skilled artisan can pick the proper thermally reversible crosslinker with proper molecular weight range.

The thermally reversible crosslinker is present in about 10 to about 90 wt %, preferably about 20 to about 50 wt %, of the total photocurable composition.

The photocurable composition also comprise a photoinitiator, including both Type I and Type II photoinitiators. Appropriate photoinitiators include phosphine oxide derivatives, triazines, ketones, peroxides, diketones, azides, azo derivatives, disulfide derivatives, disilane derivatives, thiol derivatives, diselenide derivatives, diphenylditelluride derivatives, digermane derivatives, distannane derivatives, carbo-germanium compounds, carbon-silicon derivatives, sulfur-carbon derivatives, sulfur-silicon derivatives, peresters, Barton's ester derivatives, hydroxamic and thiohydroxamic acids and esters, organoborates, organometallic compounds, titanocenes, chromium complexes, aluminate complexes, carbon-sulfur or sulfur-sulfur iniferter compounds, oxyamines. aldehydes. acetals, silanes, phosphorous-containing compounds, borane complexes, thioxanthone derivatives, coumarins. anthraquinones, fluorenones, and ferrocenium salts. Particularly desirable photoinitiators include benzophenone, anthraquinone, and fluoroenone. In one embodiment, the photoinitiator is a Norrish type I initiator selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO) or ethyl (2,4,6-trimethylbenzoyl) phenylphosphinate (TPO-L) or polymeric derivatives thereof.

Commercially available photoinitiators include OMNIRAD TPO (2,4,6-trimethylbenzoyl-diphenyl phosphine oxide), OMNIRAD 184 (1-Hydroxycyclohexyl-phenyl ketone), IRGACURE series, CHEMCURE series, DAIDO UV cure series, and the like.

When used, the photoinitiator are present in an amount of from about 0.01 to about 15 wt % of the total composition.

The photocurable composition may contain but does not require a thermal initiator.

The photocurable composition may further comprise additives, including chain transfer agent, irreversible chain transfer agent, antioxidant, hindered amine light stabilizer, amine synergist (both reactive and non-reactive), optical brighteners, UV blockers, fillers including both inorganic and organic fillers, dyes (also referred to as pigments), waxes (including wax-like additives), plasticizers or mixtures thereof. The chain transfer agents or the irreversible chain transfer agents reduce average molecular weight between crosslinks in the cured composition. The antioxidants increase storage life of photocurable composition. The hindered amine light stabilizers improve weatherability of photocurable composition. The amine synergists increase cure rate of the photocurable composition. The optical brighteners control light penetration depth during cure of photocurable composition. The UV blockers control light penetration depth during the cure, improve weatherability, and resist UV degradation of the composition. The organic and inorganic fillers provide mechanical strength by increasing stiffness or modulus and resisting abrasion and tearing of the cured composition. The dyes function as colorant and control light penetration depth during curing of photocurable composition. The waxes improve melt flowability and processing of the cured composition. The plasticizers provide mechanical strength by adding flexibility and impact resistance to cured composition, and additionally aid flowability and processing of the cured composition.

Chain transfer agents include free radical living polymerization catalyst, catalytic chain transfer agent, reversible addition fragmentation chain transfer (RAFT) agent, and iodine transfer agent for polymerization.

Particularly preferred additive is addition fragmentation chain transfer agent. Exemplary agents include allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy)styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof. The is addition fragmentation chain transfer agent can design and aid in the reversibility of the photocurable composition.

The Diels-Alder reaction of bismaleimide and furfuryl acrylate, under free radical polymerization, undergoes side reactions that form branches on the polymer backbones. This builds up the molecular weight and impacts irreversible crosslinking reaction in photocurable composition. To circumvents the branching side reactions in polymer and effectively reduce the molecular weight. The chain transfer agent is added to the photocurable composition. Adding this chain transfer reagent allows the polymer to soften at around 130° C. of the photocurable composition. This allows the photocurable composition to soften sufficiently to dissociate from the master pattern with heat.

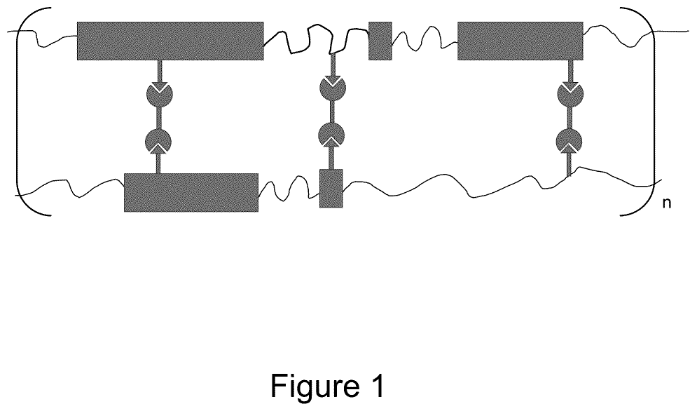

FIG. 1 is a schematic drawing of the cured photocurable composition. The boxes represent the hard segments formed from high Tg monomers. Hard segments provide rigidity and strength to the cured article. The soft segments formed from the low Tg monomers are represented by lines, these provide flexibility and toughness to the cured article. The thermally reversible crosslinkers are represented as balls that are connected to the hard segments and they can unlink and dissociate under heat. The chain transfer agents can tune the molecular weight of the polymer and decrease the unit length (n) of the polymer. Under sufficient thermal exposure the cured photocurable composition softens and melts due to dissociation of thermally reversible crosslinkers and glass transition temperature reached.

Exemplary antioxidants include butylated hydroxytoluene, 4-methoxyphenol, 4,4′-Thiobis(2-tert-butyl-5-methylphenol), 2,2′-methylenebis(6-tert-butyl-4-methylphenol), 2,5-Di(tert-amyl) hydroquinone, bis(2,4-di-tert-butylphenyl) pentaerythritol diphosphate, and tris(2, 4-di-tert-butylphenyl)phosphite.

Exemplary hindered amine light stabilizers include N,N′,N″,N″-tetrakis(4,6-bis(butyl-(N-methyl-2,2,6,6-tetramethylpiperidin-4-yl) amino)triazin-2-yl)-4,7-diazadecane-1,10-diamine, Bis(1-octyloxy-2,2,6,6-tetramethyl-4-piperidyl) sebacate, decanedioic acid, 1,10-bis(1,2,2,6,6-pentamethyl-4-piperidinyl) ester decanedioic acid, 1-methyl 10-(1,2,2,6,6-pentamethyl-4-piperidinyl), and bis (2,2,6,6-tetramethyl-4-piperidyl) sebacate.

Typical amine synergists or co-initiators commonly used with type II photoinitiators include, but are not limited to, tertiary aliphatic amines such as methyldiethanolamine, dimethylethanolamine, triethanolamine, triethylamine and N-methylmorpholine; aromatic amines such as amylparadimethylaminobenzoate, 2-n-butoxyethyl-4-(dimethylamino) benzoate, 2-(dimethylamino) ethylbenzoate, ethyl-4-(dimethylamino)benzoate, and 2-ethylhexyl-4-(dimethylamino)benzoate; and (meth)acrylated amines such as dialkylamino alkyl(meth)acrylates (e.g., diethylaminoethylacrylate) or N-morpholinoalkyl-(meth)acrylates (e.g. N, N-morpholinoethyl-acrylate).

In certain embodiments, the photocurable compositions may comprise one or more optical brighteners (i.e., optical brightening agents). Optical brighteners, optical brightening agents (OBAs), fluorescent brightening agents (FBAs), or fluorescent whitening agents (FWAs), are chemical compounds that absorb light in the ultraviolet and violet region (usually 340-370 nm) of the electromagnetic spectrum and re-emit light in the blue region (typically 420-470 nm) by fluorescence. Suitable optical brighteners include, but are not limited to, bis-benzoxazoles; coumarins; stilbenes, including triazine-stilbene, and biphenyl stilbenes; diazoles; triazoles; benzoxazolines; combinations thereof; and the like. Fluorescent brighteners are preferred. In some embodiments, optical brighteners act as a sensitizer. Commercially available optical brighteners include, but are not limited to, Optiblanc PL (3 V Sigma); Benetex OB, OB Plus, and 0B-M1 (Mayzo).

UV blockers. Any suitable filler may be used in connection with the various embodiments described herein, depending on the properties desired in the part or object to be made. Thus, fillers may be solid or liquid, organic or inorganic, and may be reactive and non-reactive rubbers, examples of all of which include siloxanes, organic phosphinates, acrylonitrile-butadiene rubbers; reactive and non-reactive thermoplastics (such as poly(ether imides), maleimide-styrene terpolymers, polyacrylates, polysulfones and polyethersulfones) inorganic fillers such as silicates (such as talc, clays, silica, or mica), glass, carbon nanotubes, graphene, carbon-fiber, metals and cellulose nanocrystals and combinations thereof.

Any suitable filler may be used in connection with the various embodiments described herein, depending on the properties desired in the part or object to be made. Thus, fillers may be solid or liquid, organic or inorganic, and may be reactive and non-reactive rubbers, examples of all of which include siloxanes, organic phosphinates, acrylonitrile-butadiene rubbers; reactive and non-reactive thermoplastics (such as poly(ether imides), maleimide-styrene terpolymers, polyacrylates, polysulfones and polyethersulfones) inorganic fillers such as silicates (such as talc, clays, silica, or mica), glass, carbon nanotubes, graphene, carbon nanostructures, carbon-fiber, artificial spider silk and derivatives, metals and cellulose nanocrystals, core-shells and combinations thereof. One or more polymeric and/or inorganic tougheners may be included in the photocurable composition. The toughener may be substantially uniformly distributed in the form of particles in the polymerized product. The particle size ranges from about 1 to about 200 μm in diameter. Such tougheners include those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, and fullerenes), ceramics and silicon carbides, with or without surface modification or functionalization. Core-shell particles whose compositions are described in U.S. Patent Application Publication Nos. 2010/0280151 and 2007/0027233, the entire contents of which are incorporated herein by reference, may also be added as fillers. In some embodiments, the fillers have an average particle size of less than 1000 nanometers (nm). Generally, the average particle size of the fillers is less than 500 nm, less than 300 nm, less than 200 nm, less than 100 nm, or even less than 50 nm. Typically, such particles are spherical, so the particle size is the diameter; however, if the particles are not spherical, the particle size is defined as the longest dimension of the particle.

Exemplarily wax and wax-like additive include microcrystalline wax, beeswax, carnauba wax, paraffin wax, polyethylene glycol wax, candelilla wax, ozokerite wax, oricurry wax, microcrystalline wax, amide wax, erucamide wax, polypropylene wax, paraffin wax, polyethylene wax, polytetrafluoroethylene wax, carnauba wax, polyethylene glycols, having a molecular weight greater than 1000 Daltons, poly (tetramethylene ether) glycols having a molecular weight over 650 Daltons, and the like. The wax may be a combination of said waxes. The wax and wax-like additive may also have a reactive or non-reactive functionality on the wax and wax-like additive.

In certain embodiments, the photocurable compositions may comprise one or more plasticizers, suitable plasticizers include, but not limited to: phthalic acid esters, esters based on benzoic acid, polyketones, esters of diphenic acid, ester of cyclohexane polycarboxylic acid, dialkyl adipate, or a mixture thereof. Some examples include: bis (2-ethylhexyl phthalate) (DEHP or DOP), diisononyl phthalate (DINP), dioctyl phthalate (DnOP), diisodecyl phthalate (DIDP), dipropylheptyl phthalate (DPHP), di-2-ethylhexyl terephthalate (DOTP or DEHT), and diisononyl-1,2 cyclohexane dicarboxylate (DIDC, an example of which is BASF's Hexamoll® DINCH®).

The photocurable composition can have additional ingredients solubilized or dispersed therein, including pigments, dyes, detectable compounds (e.g., fluorescent, phosphorescent, and radioactive), fillers, light absorbers, dispersing agents, slip agents, leveling agents, melt flow modifiers, optical brighteners, antifoaming agents, antistatic agents, UV sensitizers, waxes, plasticizers, amine synergists or co-initiators, or inhibitors of polymerization, again depending upon the particular purpose of the product being fabricated.

In certain embodiments, the photocurable compositions may comprise one or more surfactants or dispersing agents. Surfactants include but not limited to an anionic surfactant, a nonionic surfactant, a cationic surfactant, or an amphoteric surfactant. Examples of the anionic surfactant encompass fatty acid sodiums such as mixed fatty acid sodium soap and sodium stearate, higher alcohol sodium sulfate, sodium alkyl sulfate, alkyl benzene sulfonate, and the like. Examples of the cationic surfactant and the amphoteric surfactant encompass alkylamines, alkylbetaine, and the like. Examples of the dispersing agent encompass ethyl cellulose, ethyl hydroxyethyl cellulose, and the like.

In certain embodiments, the photocurable compositions may comprise one or more slip agents. Slip agents include but are not limited to silicones, such as polydimethylsiloxane (PDMS), fluoropolymers, alkyl ketal esters, and fatty acid amides. Generally fatty acid amides are derived from aliphatic saturated and/or unsaturated fatty acids containing between 16 and 22 carbon atoms, including but not limited to: erucamide, oleamide, stearamide, behenamide, oleyl palmitamide.

In certain embodiments, the photocurable compositions may comprise one or more leveling agents. Leveling agents include but are not limited to polyaminoamide and derivatives thereof, polyalkanolamine and derivatives thereof, polyethylene imine and derivatives thereof, quaternized polyethylene imine, polyglycine, poly (allylamine), polyaniline, polyurea, polyacrylamide, poly (melamine-co-formaldehyde), reaction products of amines with epichlorohydrin, reaction products of an amine, epichlorohydrin, and polyalkylene oxide, reaction products of an amine with a polyepoxide, polyvinylpyridine, polyvinylimidazole, polyvinylpyrrolidone, or copolymers thereof, nigrosines, pentamethyl-para-rosaniline hydrohalide, hexamethyl-pararosaniline hydrohalide, or compounds containing a functional group of the formula N-R-S, where R is a substituted alkyl, unsubstituted alkyl, substituted aryl or unsubstituted aryl. Typically, the alkyl groups are (C1-C6) alkyl and preferably (C1-C4) alkyl. In general, the aryl groups include (C6-C20) aryl, preferably (C6-C10) aryl. Such aryl groups may further include heteroatoms, such as sulfur, nitrogen and oxygen. It is preferred that the aryl group is phenyl or napthyl. The compounds containing a functional group of the formula N-R-S are generally known, are generally commercially available and may be used without further purification.

The additives are present in an amount of from about 0.01 to about 60 wt %. preferably from about 1-25 wt %, and more preferably from about 1 to about 10 wt % of the total composition.

The composition is then prepared by combining the components together, mixing until they are reacted. The reacted mixture applied onto a substrate or deposited as a self-supporting 3D structure either by coating, lithography and/or printing. The application includes vat polymerization, slot die coating, spray coating, wet-coating, screen-printing UV-nano-imprint lithography or photo-nano imprint lithography, step and flash imprint lithography, inkjet printing, and the like. A skilled artisan may modify the viscosity of the composition to suit the chosen application method with solvent, monomers, and rheology modifiers. Height range or the thickness of the applied structure may vary from about 1 to about 2000 μm. Higher or thicker structure may be made by multiple applications or layering the composition on the structure to build up the thickness to a desired height.

For photocuring the photocurable composition, the composition is exposed to radiation in the electromagnetic spectrum in a range of about 355 nm to about 405 nm. The radiation may be emitted from a LED source, which may be chosen from a laser, a plurality of lasers, a projector or a plurality of projectors. The LED source may be applied from beneath or from above a reservoir in which is contained the photocurable composition.

Curing is conducted by exposing the composition to an actinic radiation, UV light and visible light, which causes the composition to polymerize and harden. Single reaction mechanism energy polymerization involves the use of energy to initiate and drive the polymerization through one reaction mechanism. Irradiation through exposure to actinic radiation, UV light and Visible light. Such examples include UV light (100 nm-405 nm), Visible Light (405 nm-700 nm) or Electron beam. Examples of suitable light sources include LEDs, laser diodes, laser beams, lamps (halogen lamp, Xe, Xe-Hg lamps, etc.), LED Lasers or LED projectors used in additive manufacturing, Visible light irradiating LCD, LED or Plasma screens, mobile or tablet devices. This polymerization then is carried out through a single reaction mechanism, such as free radical, cationic, Michael addition, step-growth, click-chemistry, to name a few. The photocurable composition, which is typically in a liquid or in a viscous state, polymerizes and form a three-dimensional solid.

Optionally, after curing, the UV-cured photocurable composition may be treated with a solvent or a wash liquid. The solvent or wash liquid may be chosen from glycol ether derivatives, lower alkyl alcohols, such as isopropanol, or mild surfactants. The solvent or wash liquid may be heated to an elevated temperature in use here. In this manner, the un-reacted material on the surface of the part may be rendered flowable, to remove the un-reacted material more easily via solvation or mechanical agitation, such as sonication.

Above a specific temperature, particularly in the range of about 120 to about 200° C., more preferably in the range of about 130 to about 180° C., the UV-cured photocurable composition, and is softened. The photocurable composition can be designed by fine tuning the thermally reversible crosslinker and chain transfer agent to soften at a specific temperature within 120 to 200° C. range. In one embodiment, the photocurable composition provides high mechanical strength below 130° C. and melting at temperatures above 130° C.

Without being bound to any specific theory, the addition of difunctional monomer or oligomer with the balanced Tg imparts strength to the polymer backbone. This is akin to difunctional monomer/oligomer's irreversible crosslinking system, akin to thermoset, which does not melt under heating, but rather burns. The photocurable composition herein is designed to de-crosslink the difunctional monomer/oligomers upon heat exposure via reversible Diels-Alder reaction. The combination of the reversible Diels-Alder and chain transfer reagent that reduces side chain and decrease the overall molecular weight of the polymer allows the photocurable composition to soften at around 130° C. The photocurable composition described herein is designed to produce mechanical strength below about 130° C. while being ductile at above about 130° C. This unique set of characteristics find uses in pharmaceutical, agricultural, adhesive, and packaging industries.

The heat allows thermal reversibility of the photocurable composition. This has many uses, including additive manufacturing process and beyond. Three-dimensional printing can use used to apply the thermally reversible photocurable composition, where rework or removability is required. This composition may be applied in various ways.

An article may be formed with the photocurable composition. The photocurable composition may be applied by slot die coating, spray coating, wet-coating, screen-printing UV-nano-imprint lithography or photo-nano imprint lithography, step and flash imprint lithography, polyjet or inkjet printing to form a 3D structure.

In one embodiment, the photocurable composition can be the basis of an investment shell. A second composition may be formed on the innermost layer of the investment shell and then hardened, essentially taking the shape of the removed pattern. After curing the second composition, the investment shell can be removed either by heat or destroying it to separate from the object.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### EXAMPLES

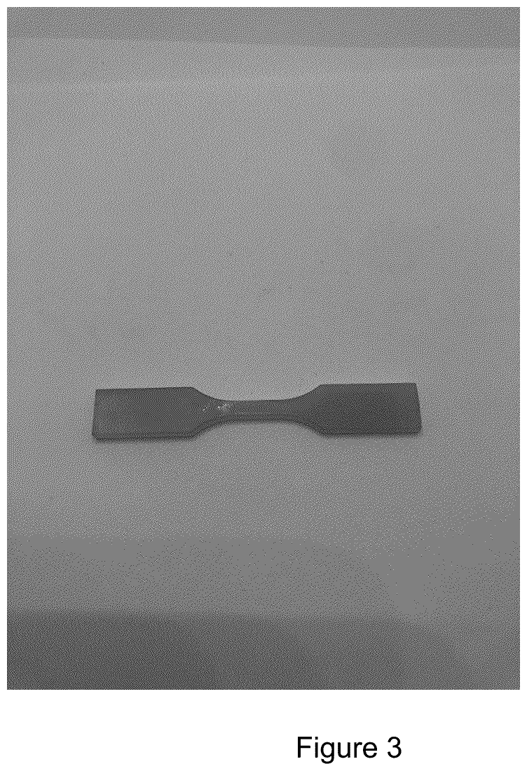

Thermally reversible crosslinker of Sample 1 was made by dissolving 1 molar equivalent of BMI-1400 Designer Molecules with centrifugal mixing, 2000 RPM for five minutes with two molar equivalents of furfuryl methacrylate. This solution was transferred to a round bottom flask and mixed at 100 RPM for eight hours at 60° C., and then cooled to 25° C. for 24 hours. The rest of the components of Sample 1, as listed in Table 1, was then combined into a vessel, and then mixed with an overhead mixer (cowles blade) at 800 RPM for two hours. The formed liquid resin was then loaded into a DLP based 3D printer, configured to print at 100-micron layers, 75 mJ/cm^2 dose per layer, and printed ASTM D638 Type IV specimens. This was post-processed by rinsing the specimens in isopropanol alcohol for two minutes, and then air dried at 25° C. for 30 minutes. Each sample was post-cured with a mercury bulb for 1500 mJ/cm^2 (total exposure energy) and then stored at 25° C. for 24 hours before testing with an Instron dual column universal testing system for tensile testing. A photograph of the tensile specimen made with Sample 1 is photographed in FIG. 3, which was printed vertically having a height of 63 mm.

DSC was run on each sample according to ASTM E794-06 (ramp rate of 5° C./min, 50 mL/min N₂ purge, at range of 25-300° C.). The DSC measurements are based on two specimen samples to determine the melting temperature. The sample at the melting temperature was further observed.

Samples 2-4 were similarly made. The thermally reversible crosslinker was made with the noted starting compounds.

TABLE 1
Examples

| Sample | 1 | 2 | 3 | 4 |
|---|---|---|---|---|
| 2-Propylheptyl acrylate | 18.00 | 18.00 | 18.00 | 6.00 |
| N-acryloylmorpholine | 13.75 | 13.75 | 13.75 | 40.75 |
| Thermally reversible | 59.00* | 59.00** | 59.00*** | 33.5* |
| crosslinker | | | | |
| Omnirad TPO | 1.50 | 1.50 | 1.50 | 1.00 |
| Omnirad 184 | 0.75 | 0.75 | 0.75 | 0.75 |
| Ethyl 2-tosyloxyacrylate | 7.00 | 7.00 | 7.00 | 18 |
| DSC melting T | 130- | None | None | None |
| | 150° C. | (FIG. | (FIG. | (FIG. |
| | (FIG. | 2B) | 2C) | 2D) |
| | 2A) | | | |
| Observation at melting | Liquid | No | No | No |
| | | melting | melting | melting |
| Stress at break | 1.6 MPa | Not | Not | Not |
| | | measured | measured | measured |
| 110% strain at break | 22 MPa | Not | Not | Not |
| | | measured | measured | measured |

*1 eq of BMI-1400 Designer Molecules + 2 eq of furfuryl methacrylate
**1 eq of BMI-1400 Designer Molecules + 2 eq of 2-propenoic acid, 2-[[2-furanylmethoxy)carbonyl]amino]ethyl ester
***1 eq of BMI-1400 Designer Molecules + 2 eq of 2-propenoic acid, 2-methyl-2-[2 furanylmethoxy)carbonyl]amino]ethyl ester

Only Sample 1 indicated reversibility: Sample 1 softened and then melted at 150° C. Only Sample 1 had a DSC melting temperature and melted. Samples 2-4 did not melt.

The stress at break and 110% strain at break were measured for Sample 1 and reported in Table 1. Stress and strain values were not measured for Samples 2-4 since they did not show any indication of reversibility.

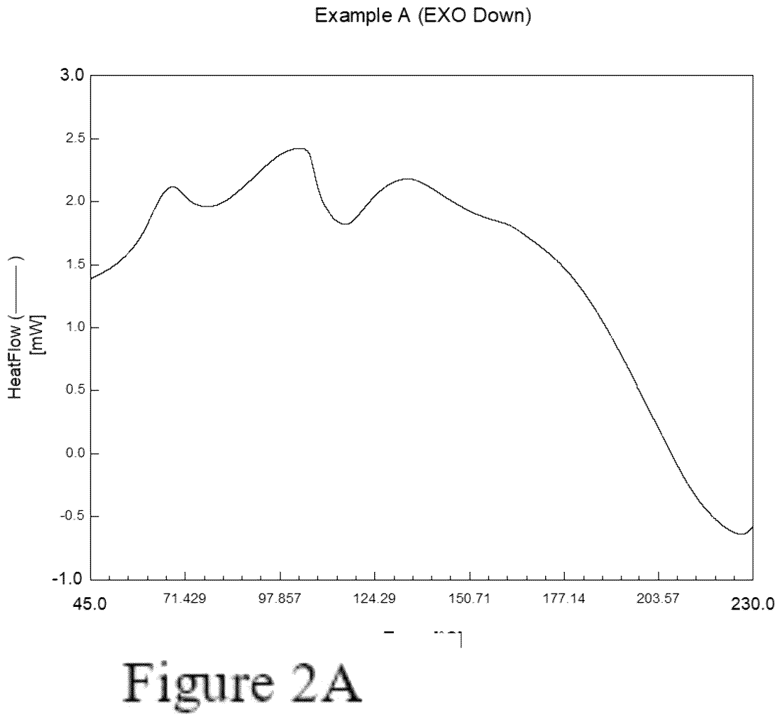

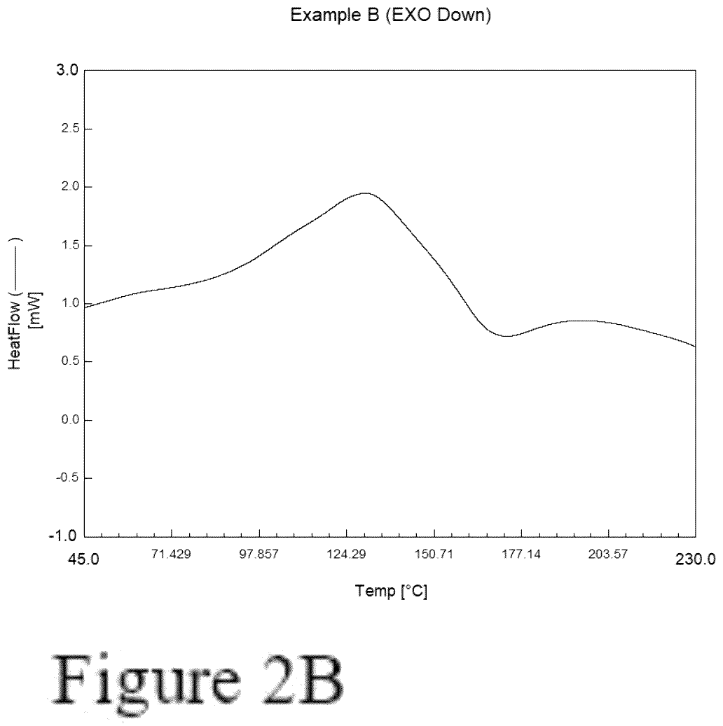

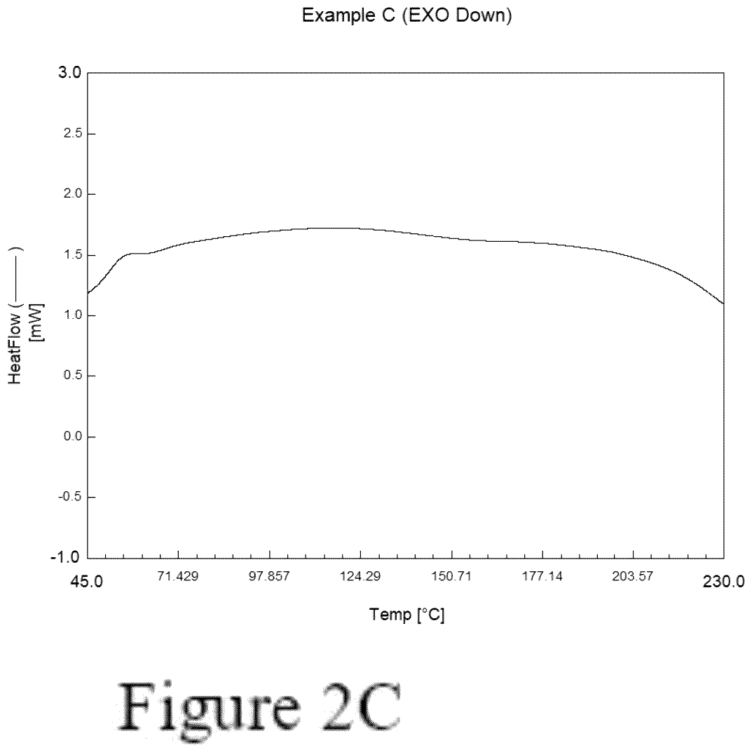

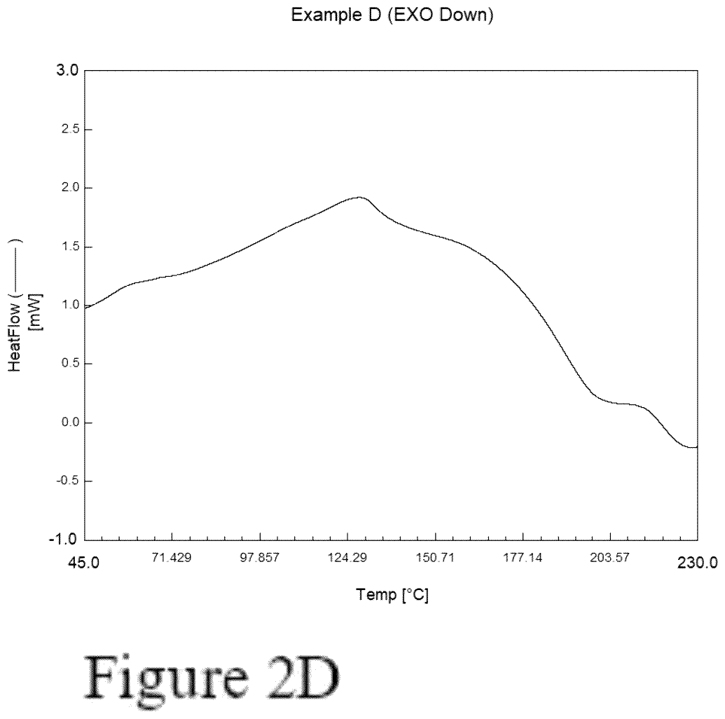

Sample 1 contains the thermally reversible cross-linker, additive for controlling MW, high Tg component, and low Tg component. As shown in FIG. 2A, there were endothermic peaks at 110° C. and 130° C., which corresponded to retro Diels-Alder reactions (thermal de-crosslinking). Additional endothermic transitions at 70° C. and 100° C. were shown in Sample 1, which is indicative of melting. Sample 1 melted into liquid above 130° C. Sample 2 did not contain the additive for controlling MW, thus only softened above 130° C., without any signs of melting.

In Sample 3, the thermally reversible crosslinker was replaced with a standard crosslinker, urethane methacrylate oligomer. As shown in in FIG. 2C, no endothermic transition occurred, and this sample remained as a thermoset and did not melt or soften at above 150° C.

Sample 4 is devoid of any low Tg component. FIG. 2D showed an endothermic peak exhibited at 130° C. that corresponded to retro Diels-Alder reaction, but the composition did not melt above 150° C. Only gel-like material formed at above 130° C. for Sample 4.

I/we claim:

1. A photocurable composition comprising:
A) a monomer A with at least one functionality having a glass transition temperature value less than about 25° C.;
B) a monomer B with at least one functionality having a glass transition temperature value greater than about 25° C.;
C) a thermally reversible crosslinker having a UV curable functionality and a thermally reversible covalent bond;
D) a photoinitiator; and
E) an additive selected from the group consisting of a chain transfer agent, irreversible chain transfer agent, antioxidant, hindered amine light stabilizer, amine synergist, optical brighteners, UV blockers, fillers, dyes, waxes, plasticizers or mixtures thereof.

2. The photocurable composition of claim 1, wherein the monomer A with at least one functionality has a functional group selected from methacrylate, acrylate, vinyl ester, vinyl ether, allyl, N-vinyl, vinylamide, acrylamide, vinyl carbonate, acryloyl, vinyl carbamate, maleimide, cyanoacrylate, thiol or epoxy.

3. The photocurable composition of claim 1, wherein the monomer A with at least one functionality has a functional group selected from methacrylate, acrylate, N-vinyl, acrylamide, maleimide or acryloyl.

4. The photocurable composition of claim 1, wherein the monomer B with at least one functionality has a functional group is selected from methacrylate, acrylate, vinyl ester, vinyl ether, allyl, N-vinyl, vinylamide, acrylamide, vinyl carbonate, acryloyl, vinyl carbamate, maleimide, cyanoacrylate, thiol or epoxy.

5. The photocurable composition of claim 4, wherein the monomer B with at least one functionality has a functional group is selected from narrow methacrylate, acrylate, N-vinyl, acrylamide, maleimide or acryloyl.

6. The photocurable composition of claim 1, wherein the thermally reversible crosslinker is prepared by reacting
a) bismaleimide or a compound having two or more maleimide group with
b) furfuryl methacrylate or furfuryl acrylate wherein the molar ratio of a to b is 0.5-2 equivalents.

7. The photocurable composition of claim 1, wherein the photoinitiator is a Norrish type I initiators selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO) or ethyl (2,4,6-trimethylbenzoyl) phenylphosphinate (TPO-L) or polymeric derivatives thereof.

8. The photocurable composition of claim 1, wherein the additive is a chain transfer agent selected from the group consisting of allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy)styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof.

9. The photocurable composition of claim 1, which has a melting temperature of about 100 to about 250° C.

10. A photocurable composition comprising:
A) a monomer A with at least one functionality having a glass transition temperature value less than about 25° C.;
B) a monomer B with at least one functionality having a glass transition temperature value greater than about 25° C.;
C) an oligomer having two or more furan maleimide Diels-Alder adduct;
D) a photoinitiator; and
E) an additive selected from the group consisting of a chain transfer agent, irreversible chain transfer agent, addition fragmentation chain transfer agent (AFCT), antioxidant, hindered amine light stabilizer, amine synergist, optical brighteners, UV blockers, fillers, dyes, waxes, plasticizers or mixtures thereof.

11. The photocurable composition of claim 10, wherein the monomer A with at least one functionality has a functional group consisting of methacrylate, acrylate, acryloyl, vinyl ester, vinyl ether, allyl, N-vinyl, and mixtures thereof.

12. The photocurable composition of claim 10, wherein the monomer B with at least one functionality has a functional group consisting of methacrylate, acrylate, acryloyl, vinyl ester, vinyl ether, allyl, N-vinyl, and mixtures thereof.

13. The photocurable composition of claim 10, wherein oligomer is prepared by reacting
a) bismaleimide or a compound having to two or more maleimide group with
b) furfuryl methacrylate or furfuryl acrylate wherein the molar ratio of a to b is 0.5-2 equivalents.

14. The photocurable composition of claim 10, wherein the photoinitiator is a Norrish type I initiators selected from 2,4,6-trimethylbenzoyl-diphenyl phosphine oxide (TPO), 1-Hydroxycyclohexyl-phenyl ketone, bis(2,4,6-trimethylbenzoyl)-phenylphosphineoxide (BAPO), ethyl (2,4,6-trimethylbenzoyl) phenylphosphinate (TPO-L) or polymeric derivatives thereof.

15. The photocurable composition of claim 10, wherein the additive is a chain transfer agent selected from the group consisting of allyl sulfide, allyl phenyl sulfone, ethyl 2-tosyloxyacrylate, ethyl 2-(1-hydroxyperoxyethyl) propenoate, mono-beta-allyl sulfone, alpha-(benzyloxy) styrene, carbon tetrachloride, carbon tetrabromide, bromotrichloromethane, 4-methylbenzenethiol, pentaphenylethane, tert-nonyl mercaptan, 4,4′-thiobisbenzenethiol, n-octyl mercaptan, thioglycolic acid, and mixtures thereof.

16. The photocurable composition of claim 10, which has a melting temperature of about 100 to about 250° C.

17. An object produced by the cured photocurable composition of claim 10.

18. A method of making a reworkable 3D printed object comprising the steps of:
1) preparing a photocurable composition comprising
a. a monomer A with at least one functionality having a glass transition temperature value less than about 25° C.;
b. monomer B h with at least one functionality having a glass transition temperature value greater than about 25° C.;
c. a thermally reversible crosslinker having a UV curable functionality and a thermally reversible covalent bond;
d. a photoinitiator; and
e. an additive selected from the group consisting of a chain transfer agent, irreversible chain transfer agent, antioxidant, hindered amine light stabilizer, amine synergist, optical brighteners, UV blockers, fillers, dyes, waxes, plasticizers or mixtures thereof; and
2) applying the photocurable composition onto a substrate as a self-supporting 3D structure; and
3) curing the self-supporting 3D structure into a photocured composition; and
4) heating the photocured composition to a temperature sufficient to soften the photocured composition to a softened composition; and
5) removing the softened composition from the substrate.

19. The method of making the reworkable 3D object comprising of claim 18, wherein the applying the photocurable composition is digital light processing, stereolithography, slot die coating, spray coating, wet-coating, screen-printing UV-nano-imprint lithography, photo-nano imprint lithography, step and flash imprint lithography, selective laser sintering, fused deposition modeling, fused filament fabrication, polyjet, or inkjet printing.

20. The method of making the reworkable 3D object comprising of claim 18, wherein the temperature in step 4) is from about 130 to about 250° C.
